(19) United States
(12) Patent Application Publication
(10) Pub. No.: US 2020/0378186 A1
(43) Pub. Date: Dec. 3, 2020

(54) LADDER STABILIZING ACCESSORY

(71) Applicant: Patrick Perreault, Ste-Julienne (CA)

(72) Inventor: Patrick Perreault, Ste-Julienne (CA)

(21) Appl. No.: 16/888,667

(22) Filed: May 30, 2020

(30) Foreign Application Priority Data
May 31, 2019 (GB) 1907816.1

(51) Int. Cl. E06C 7/48

(52) U.S. Cl. CPC E06C 7/48

(57) ABSTRACT

A ladder stabilizing accessory provides a pair of connecting brackets joined by a transverse telescoping rod. Each connecting bracket consists of a footing or leg pivotally attached at one of its ends. The legs are angularly adjustable as each bracket has a semi-circular section perforated with a plurality of openings laid in an arcuate fashion so that a pin passing through a hole in the leg can also pass through any given opening so as to lock the leg in a given angle relative to the ladder. The bracket has a clamping member that clamps unto the rail of the ladder so as to secure the bracket at a specific location on the ladder. With the help of the telescopic rod, both sides of the ladder can be secured by the pair of brackets.

### CROSS-REFERENCE TO RELATED APPLICATIONS

The present application claims priority to Request number GB1907816.1, filed on May 31, 2019 entitled “Ladder stabilizing accessory for roofers”, the disclosure of which is hereby incorporated in its entirety at least by reference.

### BACKGROUND OF THE INVENTION

### 1. Field of the Invention

The present invention relates generally to ladders but more particularly to a ladder stabilizing accessory

### 2. Description of Related Art

Ladders are very useful but they require a surface onto which their upper section needs to rest. But just leaning the ladder on a wall is not enough to securely stabilize it. In fact one of the leading cause of accidents for roofers and other tradesmen is a ladder that slides off rearwardly or laterally because it was not sufficiently secured. Also, to safely climb onto a roof, it is best to extend the ladder well beyond the roof line so that it is high enough for a worker standing up on a roof to grab the ladder with his hands and climb down.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

It is a main object of the present disclosure to provide for a ladder stabilizing accessory installed on a ladder which increase surface contact and can be adjusted at different angles and different locations along the length of the ladder.

In order to do so, a ladder stabilizing accessory configured to be installed on a pair of ladder rails of a ladder is provided, the ladder stabilizing accessory comprising a pair of connector members having an adjustable clamp configured to connect to the pair of ladder rails at any position on the ladder; a pair of leg members pivotally attached to the pair of connector members; and, a pair of footing members pivotally attached to the pair of leg members.

In one embodiment, each connector member of the pair of connector members is comprised of a semi-circular section perforated with a plurality of openings configured to accept a pin, wherein the pin is configured to pass through one opening of the plurality of openings and a hole on each leg member of the pair of leg members such that the leg member may be locked into a selected position. In one embodiment, the selected position gives the pair of leg members an angle relative to the connected ladder allowing for the ladder to be positioned at a given angle. In another embodiment, each footing member of the pair of footing members comprises a raised segment configured to plow or push debris when positioning the ladder during use. In yet another embodiment, a telescopic rod is positioned between the pair of connector members such that the distance between the pair of connector members is adjustable to accommodate various ladder widths.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1A is ladder stabilizing accessory according to an embodiment of the present invention.

FIG. 1B is an exploded view of FIG. 1A.

FIGS. 2A-B are side elevation views showing different ladder angles according to an embodiment of the present invention.

FIGS. 3A-B are top and front views according to an embodiment of the present invention.

FIG. 4A is a front view of a ladder leaning on a roof but not equipped with the invention.

FIG. 4B is a front view of a ladder leaning on a roof and equipped with the present invention.

### DETAILED DESCRIPTION OF THE PREFERRED EMBODIMENT

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide a ladder stabilizing accessory.

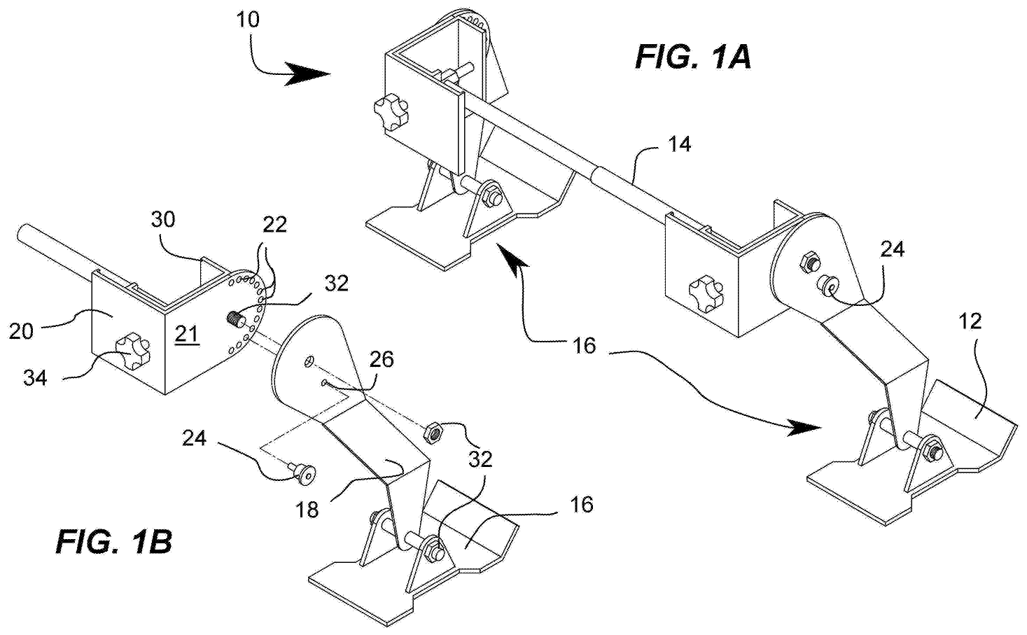

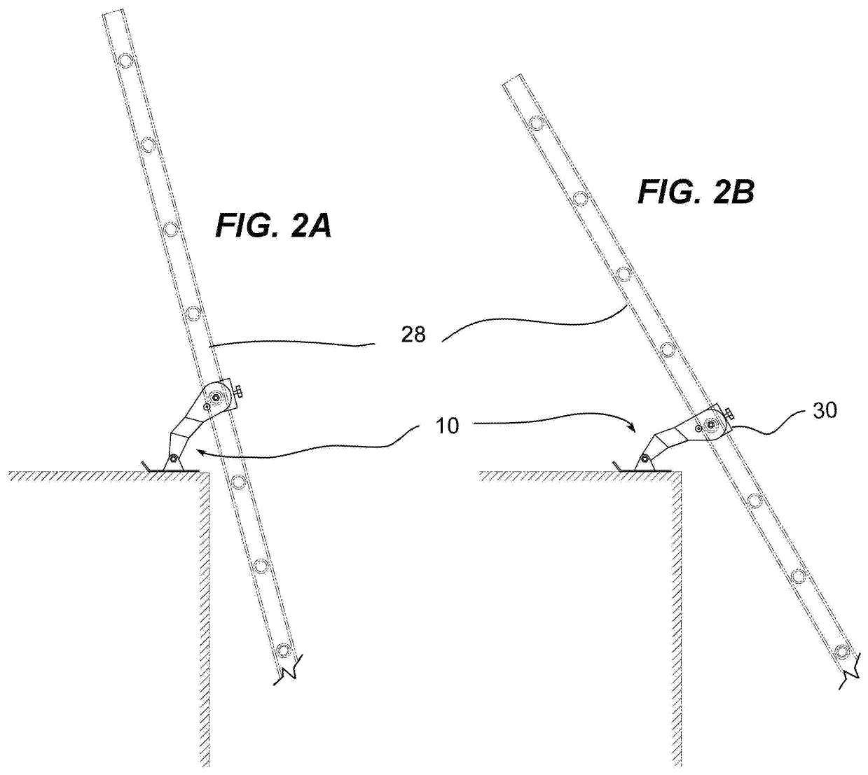

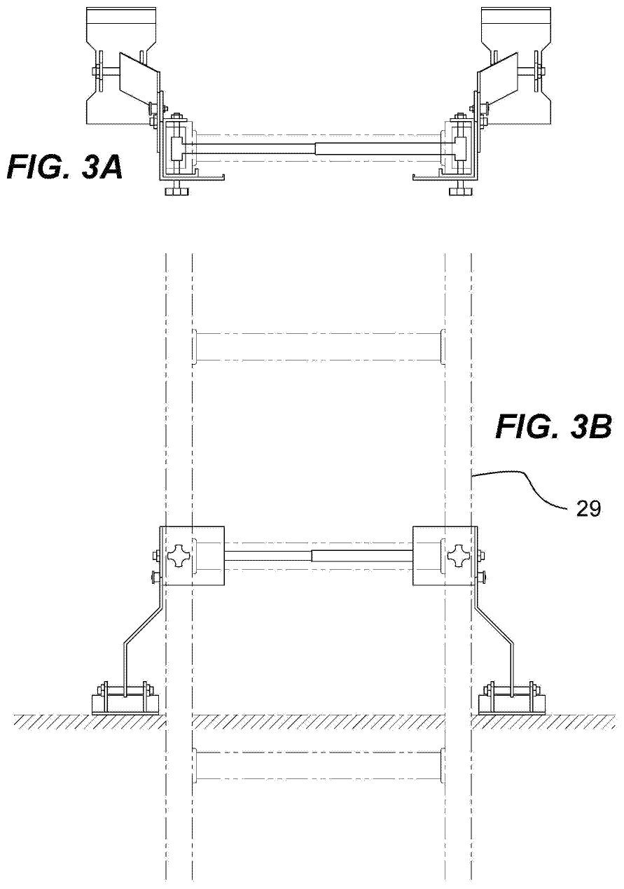

FIGS. 1-4 show various views of a ladder stabilizing accessory 10 according to an embodiment of the present invention. Referring now to any of the accompanying FIGS. 1-4, the ladder stabilizing accessory 10 is configured to be installed on a ladder 28 to stabilize the ladder during use. In one embodiment, the ladder stabilizing accessory 10 is comprised of a pair of footing members 16, wherein each footing member is pivotally attached to one end of one of a pair of leg members 18. In one embodiment, each leg member of the pair of leg members 18 is angularly adjustable at their opposite ends to one of a pair of connector members 20. In one embodiment, the pair of connector members 20 are each comprised of a semi-circular section 21 perforated with a plurality of openings 22 laid in an arcuate fashion so that a pin 24 passing through a hole 26 made into each of the pair of leg members 18 can individually lock each of the pair of leg members 18 into any one of a selection of positions as determined by the selected one of a plurality of openings 22. Advantageously, this gives the pair of leg members 18 an angle relative to the ladder 28 which allows for the ladder to be positioned at a given angle, as seen in FIGS. 2A-B showing to exemplary positions.

In one embodiment, each of the pair of footing members 16 has a raised segment 12 configured to plow or push debris and other impediments when positioning the ladder 28 during use. This is especially important since the footing members 16 sometime rests on flat roofs covered with loose aggregates wherein various debris such as twigs, leaves, etc. can otherwise prevent the footings from fully resting on the roof. The action of positioning the ladder 28 makes it so that as it moves forward, the raised segments 12 plow the debris and level the surface for a perfect resting position.

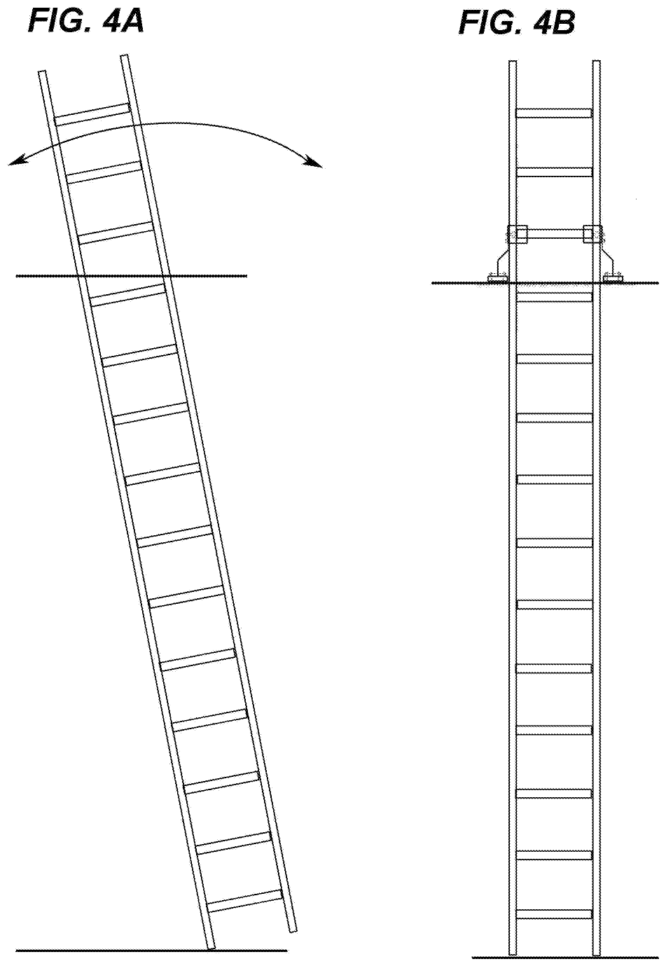

As best seen if FIGS. 2A-B, since the ladder stabilizing accessory 10 is located towards the top of the ladder 28, it offers superior stability, much more so that having spikes planted in the ground at the base of the ladder or having large footings at the base of the ladder. For example, a ladder can still tilt to the side if it only has footings at its base, as seen in FIG. 4A, whereas having the ladder stabilizing accessory 10 installed at the top of the ladder, as seen in FIG. 4B offers much better stability. With the ladder stabilizing accessory 10 resting on the rooftop, whether a flat roof or a gable roof prevents the ladder 28 from slipping at its base because it is secured and stabilized at the top. It should be understood, that the ladder stabilizing accessory 10 may be positioned anywhere on the ladder.

In some embodiments, the ladder stabilizing accessory 10 is further comprised of a pair of clamping members 30, each clamping onto a rail 29 of the ladder 28 so as to secure the stabilizing accessory 10 at a specific location on the ladder 28. With the help of the telescopic rod 14, both sides of the ladder stabilizing accessory 10 are joined to make it easier to align it equally on each side of the ladder 28. Also, the telescopic rod also allows the accessory 10 to be used with varying ladder widths. In one embodiment, nuts and bolts 32 connect the pair of leg members 18 to the connector 20 and the pair of footing members 16. Each clamping member 30 has a means for tightening (knob) 34 onto the rail 29.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

What is claimed is:

1. A ladder stabilizing accessory configured to be installed on a pair of ladder rails of a ladder, the ladder stabilizing accessory comprising:
a pair of connector members having an adjustable clamp configured to connect to the pair of ladder rails at any position on the ladder;
a pair of leg members pivotally attached to the pair of connector members; and,
a pair of footing members pivotally attached to the pair of leg members.

2. The ladder stabilizing accessory of claim 1, wherein each connector member of the pair of connector members is comprised of a semi-circular section perforated with a plurality of openings configured to accept a pin, wherein the pin is configured to pass through one opening of the plurality of openings and a hole on each leg member of the pair of leg members such that the leg member may be locked into a selected position.

3. The ladder stabilizing accessory of claim 2, wherein the selected position gives the pair of leg members an angle relative to the connected ladder allowing for the ladder to be positioned at a given angle.

4. The ladder stabilizing accessory of claim 1, wherein each footing member of the pair of footing members comprises a raised segment configured to plow or push debris when positioning the ladder during use.

5. The ladder stabilizing accessory of claim 1, further comprising a telescopic rod positioned between the pair of connector members such that the distance between the pair of connector members is adjustable to accommodate various ladder widths.
